(19) United States
(12) Patent Application Publication
(10) Pub. No.: US 2022/0287907 A1
(43) Pub. Date: Sep. 15, 2022

(54) DRY MASSAGE DEVICE

(71) Applicant: Antonin Georgiev Gechev, Hertfordshire (GB)

(72) Inventor: Antonin Georgiev Gechev, Hertfordshire (GB)

(21) Appl. No.: 17/635,799

(22) PCT Filed: Aug. 19, 2020
(86) PCT No.: PCT/EP2020/073242

§ 371 Date: Feb. 16, 2022

(30) Foreign Application Priority Data
Aug. 19, 2019 (GB) 1911882.7
Jul. 10, 2020 (GB) 2010643.1

(51) Int. Cl. A61H 9/00

(52) U.S. Cl. CPC A61H 9/0021; A61H 2009/0042; A61H 2201/1635; A61H 2201/1654; A61H 2201/169

(57) ABSTRACT

A dry massage device includes a main chamber having an inlet configured to enable fluid to enter the main chamber, and an outlet configured to enable fluid to exit the main chamber. The main chamber has a surface for contacting the patient. The device is configured such that the direction of the fluid entering the main chamber, relative to the surface for contacting the patient, is changeable by the user whilst the surface for contacting the patient remains substantially stationary relative to the patient.

### FIELD OF THE INVENTION

The present invention relates to a dry massage device; and a method for performing a dry massage on a patient using a dry massage device.

### BACKGROUND

The use of pressurised jets of water or a combination of water and air to deliver a wet massage is known for therapeutic, sporting or recreational use, including in hydrotherapy spas, hot tubs, and whirlpool spas. In these uses, the water jets are typically positioned below the water line and the user sits substantially submerged in the water in the tub. The water jets remain stationary and cannot be moved by the user whilst the device is in use. In use, the force of the water jets against the user's body, along with the turbulence caused in the water of the tub by the jets, provides a soothing massage effect.

The positioning of the water jets below the water line has the benefit of minimising the amount of splashing that occurs, both onto the user and the area surrounding the tub. However, the positioning of the jets is generally fixed or not manipulatable by the user whilst the massage is being administered, so the ability to deliver a targeted massage is limited as it requires the user to move themselves in relation to the jet. This is cumbersome and difficult for users with restricted mobility.

In medical applications, such as in-patient and out-patient clinics, a hand-held high-pressure water jet may be employed. This has the advantage of enabling the user to manipulate the position of the water jet, facilitating the massage of almost any area of the body. The pressure may also be easily controlled by moving the jet closer to or further from the patient. However, these hand-held devices cause large amounts of splashing and the user and the patient must change out of their usual clothes in order to perform a massage. Furthermore, the large volume of water splashing limits the use of such a device to an area with suitable drainage capabilities, which makes them unsuitable for use as a portable device and limits the utility significantly.

The present invention addresses, at least to an extent, these and other problems with the prior art.

### SUMMARY OF THE INVENTION

Accordingly, in a first aspect, the present invention provides a dry massage device comprising a main chamber, wherein the main chamber comprises an inlet configured to enable fluid to enter the main chamber, and an outlet configured to enable fluid to exit the main chamber. The main chamber being defined by an outer wall including a surface for contacting a patient. The device is configured such that, in use, the direction of the fluid entering the main chamber can be changed, relative to a surface contacting the patient, by a user whilst said surface remains substantially stationary relative to the patient.

For the purpose of the invention, stationary means that the area of the main chamber that is in contact with the patient does not slide across the surface of the patient during normal use. Typically, the surface of the patient will be an area of the patient's skin. The ability to change the direction of the fluid as it enters the main chamber enables a targeted massage to be delivered to an area of the patient larger than the size of the fluid inlet, without the need for either the main chamber to be repositioned, or alternatively for the patient to move.

The device is a dry massage device and, as such, both the user and the patient are not contacted by the fluid (e.g. water or aqueous solution) during normal operation of the device.

The device is configured to have an outlet through which fluid may exit the main chamber. Therefore, the pressure in main chamber does not exceed a predetermined threshold. Advantageously, this ensures that main chamber does not overfill with fluid and/or inflate, which could cause damage to the device. The fluid outlet may passively or actively remove fluid from the chamber. When the fluid outlet actively removes fluid from the main chamber, the fluid may be pumped by a pump system, which may be the same pump system that may be used to pump fluid through the fluid inlet. Where the fluid outlet is passive, water may simply drain from outlet into a drainage system or a water collection system. Preferably, the fluid outlet is an active outlet in fluid communication with a pump system that recirculates fluid to the fluid inlet of the main chamber.

Typically, the main chamber has a volume of from about 3 to about 6 litres. The larger the volume of the main chamber, the easier it is to control the pressure applied to the patient. Devices with a larger volume main chamber (e.g. 6 litres) may require external support.

Typically, the fluid inlet may be located at a first end of the main chamber and the patient contact surface may be located at a second end of the main chamber, opposite the first end. The fluid inlet may be incorporated into a handle of the device. Typically, fluid entering the main chamber is directed towards the surface for contacting the patient.

Typically, the fluid outlet may be located at the first end of the main chamber, preferably such that it is adjacent to the fluid inlet.

The main chamber may comprise a relatively rigid portion comprising the fluid inlet and/or fluid outlet, and a relatively flexible portion comprising the patient engagement surface.

Preferably, in use, the fluid inlet may be movable relative to the surface for contacting the patient whilst said surface for contacting the patient is in stationary contact with the patient. Typically, the angle formed between a longitudinal axis of the fluid inlet and the surface for contacting the patient may be varied whilst the surface for contacting the patient remains substantially stationary.

Preferably, the fluid inlet may be moved in a plane that is substantially parallel to the surface for contacting the patient, whilst said surface for contacting the patient is in stationary contact with the patient. Preferably, the fluid inlet may be moveable in a direction tangential to the plane parallel to the surface for contacting the patient.

Moving the fluid inlet towards the patient may increase the pressure applied to the treatment surface, whereas moving the fluid inlet away from the patient may reduce the pressure applied to the treatment surface. This is because moving the fluid inlet away from the treatment surface may increase the body of fluid between the fluid inlet and the wall of the chamber. Thus, advantageously, the vigour of the massage may be varied without having to alter the pressure of the fluid at the inlet.

Moving the fluid inlet in a direction parallel to the patient may enable the area of the patient being treated to be increased. This is because the fluid inlet may be moved such that it can be directed at areas of the treatment surface that would not be reached were the fluid inlet in a fixed position.

In embodiments, the portion of the main chamber in contact with the patient may be varied whilst the surface of the main chamber that is in contact with the patient remains substantially stationary. This may enable the chamber to be moved over the patient without sliding. This mechanism of movement may be considered similar to the motion of a caterpillar track.

Advantageously, this arrangement may increase the area of the patient that can be treated without having to remove or slide the main chamber. Similarly, the total area of the surface of the main chamber in contact with the patient may preferably be increased or decreased as the fluid inlet is moved towards or away from the treatment surface, respectively.

Typically, the fluid inlet may comprise an inlet nozzle, wherein said inlet nozzle may be movable within the main chamber.

Typically, the inlet may be configured such that the distance from the fluid inlet nozzle to the surface for contacting the patient is variable. Preferably, the fluid inlet nozzle may be inserted into the main chamber through a nozzle inlet, such that fluid may flow through the inlet nozzle into the main chamber.

Typically, the inlet nozzle may be coupled to the main chamber by a set of rollers and/or a flexible seal. In some embodiments the inlet nozzle may be detachably coupled to the main chamber. Alternatively, the inlet nozzle may be permanently coupled to the main chamber.

In embodiments wherein the inlet nozzle is detachable, the chamber may comprise a seal that forms a fluid-tight seal with the fluid inlet nozzle. Thus, said seal ensures that the fluid cannot escape the main chamber through the nozzle inlet. Preferably, the seal may be configured such that the nozzle is in a slidable relationship with the seal.

Typically, the main chamber may comprise a wall comprising a flexible membrane. In use, the flexible membrane may provide the surface for contacting the patient. Preferably, the flexible membrane may be conformable to substantially the shape of the portion of the patient with which it is engaged.

Typically, the flexible membrane may be made from a material from the group consisting of elastomers and thermoplastics.

In some embodiments, the main chamber may have single-walled configuration, comprising a relatively flexible wall, preferably a relatively flexible polymeric membrane. Preferably, the relatively flexible wall may be sufficiently flexible that it may conform to substantially the shape of the portion of the patient with which it is engaged, and may transmit the pressure of the fluid entering the main chamber to the surface of the patient.

The membrane may be made from a material selected from the group consisting of thermoplastics (polyethylene, polypropylene, polyvinyl chloride) and elastomers. Silicone elastomers are particularly preferred. The outer surface of the flexible membrane may be textured. A textured surface may be employed to improve the grip of the surface of the flexible membrane on the patient and reduce the likelihood of slipping.

In single-walled embodiments, the fluid entering the main chamber may engage an internal surface of a portion of the wall of the main chamber that is in contact with the patient.

In alternative embodiments, the main chamber may have a dual-walled configuration, comprising an inner wall that is relatively elastic, substantially surrounded by an outer wall that is relatively inelastic. The inner wall preferably comprises a relatively elastic polymeric membrane. Preferably, the inner wall may be flexible. The membrane may be made from a material selected from the group consisting of thermoplastics (polyethylene, polypropylene, polyvinyl chloride) and elastomers. Silicone elastomers are particularly preferred.

The outer wall may be relatively inelastic. Preferably the outer wall may be a flexible membrane. Advantageously this may enable the outer wall to conform to substantially the shape of the portion of the patient with which it is engaged, whilst enclosing and supporting the inner wall. The outer wall may beneficially prevent the inner wall from sliding over the surface of the patient, particularly in embodiments wherein the main chamber has a large volume, for example greater than 4 litres. Since the outer wall may be substantially inelastic, it may assist in maintaining the structure of the main chamber and may support at least part of the fluid weight. Thus, the outer wall may enable the user to control the amount of fluid weight that is applied to the surface of the patient.

Preferably, the inner wall may be in slidable contact with the outer wall. Alternatively, the inner wall may be in stationary contact with the outer wall.

Preferably, the outer wall may be detachably connected to the relatively rigid portion of the main chamber by attachment means, such that the outer wall can be removed from the device. The skilled person will appreciate that there are many suitable attachment means by which the outer wall may be detachably connected to the relatively rigid portion. For example, the attachment means may comprise hook and look fasteners, snap-fit fasteners, screws, press stud fasteners, zip fasteners, or threaded fasteners, such as nuts and bolts.

The outer wall may be designed for single use, whereby after each use of the device, the outer wall is detached and replaced. Advantageously, this may eliminate any requirements to clean the outer wall, improving hygiene.

The use of embodiments with a dual-walled main chamber is largely similar to that of a single-walled main chamber embodiment, except that the fluid entering the main chamber may engage an internal surface of a portion of the inner wall of the main chamber, such that the pressure of the fluid entering the main chamber is transmitted through the inner wall to the outer wall, which provides the surface for contacting the patient, to the surface of the patient to be treated.

In some embodiments, the main chamber may further comprise one or more inflatable support members. Each of the one or more inflatable support members may be in fluid communication with the main chamber. For the purposes of the invention, inflatable means that the support members can be inflated with fluid, which may be a liquid, for example water.

The one or more inflatable support member may comprise a collapsible frame.

The one or more inflatable support members may comprise generally tubular members, pouches, or other inflatable structures. Preferably, the inflatable support members comprise one or more generally tubular members. For the purpose of the invention the generally tubular members may have a non-circular cross-section; however, equally it may be circular. Similarly, the area of the cross-section may vary along the length of the generally tubular member or remain constant. Typically, references to the shape of an inflatable support member refers to its shape when substantially fully inflated.

One or more inflatable support member may comprise a first opening at or towards a first end of the inflatable support member, and a second opening at or towards a second end of the inflatable support member. Preferably, the second end is located closer to the surface for contacting the patient than the first end. The first opening and second openings may be in fluid communication with the main chamber, for instance in the form of apertures in the outer wall of the main chamber.

Typically, the first opening is located adjacent to the fluid inlet of the main chamber. The main chamber may comprise a surface for contacting the patient. Preferably, the second opening is located towards the surface for contacting the patient.

Typically, the one or more inflatable support members are directly connected to the outer wall of the main chamber, preferably an inner or outer surface of the outer wall of the main chamber. Most preferably, the one or more inflatable support members are directly connected to an internal surface of the outer wall of the main chamber. In embodiments comprising a dual-walled main chamber, preferably the one or more inflatable support members may be directly connected to the innermost wall defining the main chamber, more preferably to an internal surface of the innermost wall defining the main chamber. The one or more inflatable support members may be directly connected by adhesive, stitching, heat or sonic welding, or other means.

Typically, the device comprises from about 1 to about 10 inflatable support members. Preferably, the device comprises from about 2 to about 6 inflatable support members, for example 4 inflatable support members.

In embodiments comprising a plurality of inflatable support members, two or more of said inflatable support members may be connected, or alternatively they may be separate. Preferably, each inflatable support member is separate from the other inflatable support members. That is to say, each inflatable support member may be separated from an adjacent support member by an area of the outer wall of the main chamber.

Typically, the one or more inflatable support members are located between the inlet and the surface for contacting the patient.

Typically, one or more inflatable support member is arranged to extend from the fluid inlet towards the surface for contacting the patient, the first end of the inflatable support member being positioned proximal to the fluid inlet. Preferably, all of the inflatable support members are configured to extend from the fluid inlet towards the surface for contacting the patient. Typically, the inflatable support members are substantially evenly spaced about the fluid inlet.

Typically, the one or more inflatable support members are configured such that, during use, fluid entering the main chamber may flow into the first opening of at least one inflatable support member, along the longitudinal length of the inflatable support member, and exit through the second opening. Preferably, the fluid entering each inflatable support member from the fluid inlet may create a localised pressure increase therein in relation to the fluid pressure within the main chamber. Said localised fluid pressure may cause the one or more inflatable support member to inflate and provide increased structural rigidity to the main chamber.

Advantageously, this increased structural rigidity may provide improved support for the chamber when the device is in use and/or when the device is being repositioned on the patient. This may make manually moving the device easier for the user. The inflatable support members may be considered akin to providing a skeletal structure to the main chamber.

When fluid flow is ceased within the chamber, the localised pressure within the inflatable support members may reduce, causing the inflatable support members to deflate. Fluid within the inflatable support members may exit via the second opening and/or the first opening of the respective inflatable support members. When deflated, the inflatable support members provide little structural rigidity to the main chamber.

The size and/or shape of the second opening may be configured to ensure that each inflatable support member provides adequate support for the main chamber. For the purposes of the invention, adequate support may depend on the number of inflatable support members, their dimensions, and their arrangement in the main chamber. Preferably, the second opening may have a smaller cross-sectional area than the first opening. The exact configurations and dimensions of the first and/or second openings may be selected according to the rigidity that each inflatable support member is required to provide.

The first opening and/or second opening of each inflatable support member may comprise an aperture or a valve. For example, the valve may comprise a one-way valve or a slit valve. Preferably, the first opening may comprise a one-way valve and/or the second opening may comprise a slit valve.

In embodiments wherein the inflatable support members are generally tubular, each generally tubular member may be substantially tubular or may be substantially conical. For example, the cross-sectional area of a generally tubular member may reduce between the first opening and the second opening.

Typically, the one or more inflatable support members are each in the form of an inflatable chamber defined by at least one wall. The wall of each inflatable chamber may form a part of the outer wall of the main chamber. Preferably, the wall defining the inflatable chamber may be substantially tubular.

Typically, the wall of the main chamber comprises a flexible membrane. The inflatable support members may comprise the same materials as that of the flexible membrane of the main chamber. Typically, the inflatable support member may be made from a material selected from the group consisting of elastomers, thermoplastics, and combinations thereof.

In embodiments, the fluid inlet may comprise a fluid inlet nozzle. The inlet may be configured such that the distance from a fluid inlet nozzle to the surface for contacting the patient is variable.

In embodiments wherein the inlet is configured such that the distance from the fluid inlet nozzle to the surface of contacting the patient is variable, the position of the fluid inlet nozzle may be used to control fluid flow into the one or more inflatable support members. Preferably, when the fluid inlet nozzle is retracted towards the nozzle inlet, the fluid flow into one or more inflatable support members may increase, thereby inflating the inflatable support members. Conversely, when the fluid inlet nozzle is inserted further into the main chamber, the fluid flow into one or more inflatable support members may reduce. This may result in the deflation of one or more inflatable support members.

Beneficially, such embodiments enable the operator of the device to manually control the rigidity of the inflatable support members. Therefore, when moving and positioning the main chamber, the fluid inlet nozzle can be retracted to increase the rigidity of the inflatable support members. Whereas, when massaging the patient, the fluid inlet nozzle can be inserted further into the main chamber.

The specific shape, number, and arrangement of the inflatable support members can be selected according to the dimensions of the main chamber. This may be beneficial for designing devices that are configured for massaging specific body parts, for example, the back, shoulders, or legs.

Typically, the device may further comprise a pump system for supplying fluid to the fluid inlet. The fluid may be supplied to the main chamber through a first pipe coupled to the fluid inlet and/or inlet nozzle by a fluid-tight coupling. The fluid may be removed from the main chamber through a second pipe, coupled to the fluid outlet by means of a second fluid-tight fitting. Such pipes must be capable of withstanding fluid pressures of up to about 300 kPa (3 bar). The first and second pipes may be made from a flexible material such as, for example, polyvinyl chloride or rubber. The use of a flexible material for the first and second pipes eases the task of maneuvering the main chamber during use of the device into different positions, and also allows for more compact storage when the device is not in use.

The pipes may comprise a dual wall arrangement, such that they comprise an internal tube made from a waterproof material, surrounded by an external tube or wrapping made from a more durable material, providing protection for the internal tube. Having an external tube made from a tougher material provides the benefit of protecting the inner pipe from wear, thus lengthening the lifespan of the part. This dual wall arrangement may, for example, comprise an ethylene propylene diene monomer rubber core surrounded by a braided stainless-steel sheath. However, the skilled person will appreciate that a large variety of material combinations may be selected, so long as they provide the properties referred to above.

The first and/or second pipes may each comprise a releasable coupling by which they connect with the main chamber. Therefore, the first and/or second pipes can be detached from the main chamber by the user. The ability to detach the first and/or second pipes from the main chamber offers several advantages, including ease of access to the main chamber for maintenance when one or both of the pipes have been detached. Additionally, detachable pipes provides the ability to replace an individual component if it is damaged rather than the entire device, along with improved ease of storage and transport of the device.

The device may comprise a pump system for providing pressurised fluid to the main chamber. The pump system may be operatively connected to the main chamber by the first pipe. Suitable pump systems are known by the skilled person and include, by way of example, the POLYPROMSYNTES Aqua Optimum, the TRIBOYO T2, or the ULTRAGEL HUNGARY OM 217.

In embodiments, the fluid exiting the main chamber by the fluid outlet may be recirculated via the pump system back into the main chamber via the fluid inlet. The fluid may flow between the fluid outlet and the fluid pump system through the second pipe. Recirculating the fluid around the device beneficially may enable the device to operate as a closed system. This may improve the portability of the device, and allow it to be operated almost anywhere, for example in a patient's home. It also enables the fluid to remain contained within the device throughout use, which may ensure that neither the user nor patient contact the fluid at any point during operation.

The fluid pump system may further comprise means enabling the user to change the pressure of the fluid and hence the velocity at which the fluid is propelled through the first pipe and into the main chamber. This enables the force of the massage to be varied by the user.

Alternatively, the device may comprise means for connecting the main chamber to a mains water supply, for example a hose that can be attached to a tap.

The temperature of the fluid within the device may be variable between about 5° C. and about 42° C. Preferably, the user may be able to vary the temperature of the fluid within the device. Enabling the temperature of the fluid within the device to be changed provides a range of therapeutic benefits, as the temperature of the fluid within the device will affect the temperature of the area of the patient onto which the treatment is being applied.

By employing fluid with a temperature below 15° C., preferably below 10° C., the area of the patient that is being massaged may also be cooled. This can provide therapeutic effects such as reducing inflammation, relieving pain, etc. Conversely, by employing fluid within the device at or above body temperature, preferably up to about 42° C., will result in an increase of the temperature of the area of the patient that is being massaged. This can promote blood flow to the area and/or relax the surrounding muscles.

Preferably, the device may further comprise a temperature management system. Such a temperature management system may include a thermostat, preferably configured to measure and maintain the temperature of the fluid within the device within ±2° C. of a temperature pre-selected by the user. The temperature management system may further comprise an interface comprising a screen, upon which the measured temperature of the fluid within the device is displayed. Preferably, the screen may further show information such as the selected temperature for the fluid within the device, the pressure of the fluid within the device, etc. The interface may further be configured to enable the user to vary the temperature of the fluid within the device.

The fluid contained within the device may preferably comprise water. The fluid may further comprise a mixture of water and one or more other fluid in combination. The skilled person can appreciate that other fluids/mixtures can be used. When the fluid is a liquid, preferably it is substantially free from bubbles.

The device may comprise an integrated handle configured to facilitate the manipulation, transportation, and support of the main chamber. The integrated handle may be coupled to the main chamber by one or more movable joints or alternatively may be rigidly coupled to the main chamber, such as by forming a unitary structure with a relatively rigid portion of the main chamber.

As discussed, the main chamber may comprise both a relatively rigid portion and a relatively flexible portion, wherein the relatively rigid portion comprises the fluid inlet and/or the fluid outlet. The relatively rigid portion may be metallic (copper, stainless-steel, aluminium, etc.), or comprise one or more polymers (thermosets, polycarbonate, etc.) or a composite such as a glass or carbon reinforced polymer.

The device may be operated for massaging the user, i.e. the user and the patient as described throughout are one and the same person.

In a further aspect, the present invention provides a method of performing a dry massage on a patient, comprising the steps of:
a. positioning a dry massage device comprising a main fluid chamber onto an area of the patient to be massaged,
b. at least partially filling the main chamber with fluid through an inlet,
c. varying the direction of the fluid entering the main chamber in order to massage the patient whilst the surface of the main chamber in contact with the patient remains substantially stationary.

Advantageously, this method enables both the user and the patient to not be contacted by the fluid during normal operation of the device. Furthermore, this method increases the area of the patient that can be treated without having to remove or slide the main chamber.

Preferably, the step of at least partially filling the main chamber with fluid through an inlet may comprise filling the volume of the chamber by more than 50%, preferably by more than 70%, more preferably by more than 90%, for example 95%. Advantageously, this will reduce the likelihood of any air within the main chamber causing disruption of the pump function.

Typically, the method may further comprise the step of moving the fluid inlet relative to the surface in contact with the patient, whilst said surface remains in substantially stationary contact with the patient.

Typically, the fluid may comprise water.

In a further aspect, the invention provides a method for performing a dry massage using the a dry massage device comprising a main chamber, which comprises an inlet configured to direct fluid entering the main chamber towards a surface of the device in contact with a patient, and an outlet configured to enable fluid to exit the main chamber, wherein the fluid exiting the main chamber via the fluid outlet is recirculated via a fluid pump system to the fluid inlet.

Typically, the method further comprises the step of moving the inlet relative to the surface in contact with the patient, whilst said surface remains in substantially stationary contact with the patient.

The dry massage device may be as described in earlier aspects and embodiments of the invention.

In a further aspect, the present invention provides a dry massage device comprising a main chamber, which comprises an inlet configured to direct fluid to entering the main chamber in a direction towards a surface of the main chamber in contact with a patient, and a fluid outlet configured to enable fluid to exit the main chamber, wherein the fluid exiting the main chamber via the fluid outlet is recirculated via a fluid pump system back into the main chamber through the inlet.

Typically, the temperature of the fluid within the dry massage device may be from about 5° C. to about 42° C. Preferably, the device may comprise a temperature management system, preferably a including a thermostat. Typically, the fluid is liquid, preferably wherein the fluid comprising water.

Typically, the main chamber may comprise a patient engagement surface and wherein, in use, the fluid inlet may be moveable relative to the patient engagement surface whilst the patient engagement surface remains substantially stationary.

In a further aspect, the present invention provides a dry massage device comprising a main chamber defined by an outer wall including a surface for contacting a patient. The main chamber comprises an inlet configured to enable fluid to enter the main chamber for massaging a patient, and an outlet configured to enable fluid to exit the main chamber. The main chamber further comprising one or more inflatable support members. Each inflatable support member may be in fluid communication with the main chamber. For the purposes of the invention, inflatable means that the support members can be inflated with fluid, which may be a liquid or gas, for example water.

The one or more inflatable support members may comprise a collapsible frame.

Typically, the one or more inflatable support members may comprise generally tubular members, pouches, or other inflatable structures. Preferably, the inflatable support members comprise one or more generally tubular members. For the purpose of the invention the generally tubular members may have a non-circular cross-section; however, equally it may be circular. Similarly, the area of the cross-section may vary along the length of the generally tubular member or remain constant. Typically, references to the shape of an inflatable support member refers to its shape when substantially fully inflated.

In some embodiments, one or more inflatable support member may comprise a first opening at or towards a first end of the inflatable support member, and a second opening at or towards a second end of the inflatable support member, preferably the second end is located closer to the surface for contacting the patient than the first end. The first and second openings may be in fluid communication with the main chamber, for instance in the form of apertures in the outer wall of the main chamber.

Typically, the first opening is located adjacent to the fluid inlet of the main chamber. The main chamber may comprise a surface for contacting the patient. Preferably, the second opening is located towards the surface for contacting the patient.

Typically, the one or more inflatable support members are configured such that, during use, fluid entering the main chamber may flow into the first opening of at least one inflatable support member, along the longitudinal length of the inflatable support member, and exit through the second opening. Preferably, the fluid entering each inflatable support member from the fluid inlet may create a localised pressure increase therein in relation to the fluid pressure within the main chamber. Said localised fluid pressure may cause the one or more inflatable support member to inflate and provide increased structural rigidity to the main chamber.

Advantageously, this increased structural rigidity may provide improved support for the chamber when the device is in use and/or when the device is being repositioned on the patient. This may make manually moving the device easier for the user. The inflatable support members may be considered akin to providing a skeletal structure to the main chamber.

When fluid flow is ceased within the chamber, the localised pressure within the inflatable support members may reduce, causing the inflatable support members to deflate. Fluid within the inflatable support members may exit via the second and/or the first opening of the respective inflatable support members. When deflated, the inflatable support members provide little structural rigidity to the main chamber.

The size and/or shape of the second opening may be configured to ensure that each inflatable support member provides adequate support for the main chamber. For the purposes of the invention, adequate support may depend on the number of inflatable support members, their dimensions, and their arrangement in the main chamber. Preferably, the second opening may have a smaller cross-sectional area than the first opening. The exact configurations and dimensions of the first and/or second openings may be selected according to the rigidity that it is required to provide.

The first opening and/or second opening of each inflatable support member may comprise an aperture or a valve. For example, the valve may comprise a one-way valve or a slit valve. Preferably, the first opening may comprise a one-way valve and/or the second opening may comprise a slit valve.

The first opening of one or more inflatable support member may be fluidly connected to the inlet upstream of where fluid may flow from the inlet into the main chamber. Preferably the first opening of one or more inflatable support member may comprise a sealable valve. The sealable valve may be operable to change between a sealed configuration in which fluid may not flow from the fluid inlet into the first opening, and an unsealed configuration in which fluid may flow from the fluid inlet into the first opening. Preferably, the sealable valve may be operable by the user via a switch. The switch may be located on the handle of the main chamber.

In some alternative embodiments, one or more inflatable support member may comprise a first opening in fluid communication with a region exterior to the main chamber. Preferably, the first opening is a sealable port or valve through which fluid may enter and/or exit the inflatable support member.

Fluid, for example air, may enter the inflatable support member by connecting a fluid pump to the sealable valve or port. Alternatively, a user may inflate the inflatable support member by blowing air into the inflatable support member through the sealable port or valve. Preferably, once the inflatable support member is inflated, the sealable valve or port may be sealed. To deflate the inflatable support member, the sealable valve or port may be unsealed to enable fluid to exit the inflatable support member. A plurality of inflatable support members may be fluidly connected such that they may be collectively inflated and deflated via a single sealable valve or port. Alternatively, each inflatable support member may have its own sealable valve or port.

When inflated, the one or more inflatable support member may provide increased structural rigidity to the main chamber. Advantageously, this increased structural rigidity may provide improved support for the chamber when the device is in use and/or when the device is being repositioned on the patient. This may make manually moving the device easier for the user. The inflatable support members may be considered akin to providing a skeletal structure to the main chamber. When deflated, the inflatable support members provide little structural rigidity to the main chamber.

Typically, the one or more inflatable support members are directly connected to the outer wall of the main chamber, preferably an inner or outer surface of the outer wall of the main chamber. Most preferably, the one or more inflatable support members are directly connected to an internal surface of the outer wall of the main chamber. In embodiments comprising a dual-walled main chamber, preferably the one or more inflatable support members may be directly connected to the innermost wall defining the main chamber, more preferably to an internal surface of the innermost wall defining the main chamber. The one or more inflatable support members may be directly connected by adhesive, stitching, heat or sonic welding, or other means.

Typically, the device comprises from about 1 to about 10 inflatable support members. Preferably, the device comprises from about 2 to about 6 inflatable support members, for example 4 inflatable support members.

In embodiments comprising a plurality of inflatable support members, two or more of said inflatable support members may be connected, or alternatively they may be separate. Preferably, each inflatable support member is separate from the other inflatable support members. That is to say, each support member may be separated from an adjacent support member by an area of the outer wall of the main chamber.

Typically, the one or more inflatable support members are located between the inlet and the surface for contacting the patient.

Typically, one or more inflatable support member is arranged to extend from the fluid inlet towards the surface for contacting the patient, the first end of the inflatable support member being positioned proximal to the fluid inlet. Preferably, all of the inflatable support members are configured to extend from the fluid inlet towards the surface for contacting the patient. Typically, the inflatable support members are substantially evenly spaced about the fluid inlet.

In embodiments wherein the inflatable support members are generally tubular, each generally tubular member may be substantially tubular or may be substantially conical. For example, the cross-sectional area of a generally tubular member may reduce between the first opening and the second opening.

Typically, the one or more inflatable support members are each in the form of an inflatable chamber defined by at least one wall. The wall of each inflatable chamber may form a part of the outer wall of the main chamber. Preferably, the wall defining the inflatable chamber may be substantially tubular.

Typically, the wall of the main chamber comprises a flexible membrane. The inflatable support members may comprise the same materials as that of the flexible membrane of the main chamber. Typically, the inflatable support member may be made from a material selected from the group consisting of elastomers, thermoplastics, and combinations thereof.

In embodiments, and as in previous aspects, the inlet may comprise a fluid inlet nozzle. The inlet may be configured such that the distance from a fluid inlet nozzle to the surface for contacting the patient is variable.

In embodiments wherein the inlet is configured such that the distance from the fluid inlet nozzle to the surface of contacting the patient is variable, the position of the fluid inlet nozzle may be used to control fluid flow into the one or more inflatable support members. Preferably, when the fluid inlet nozzle is retracted towards the nozzle inlet, the fluid flow into one or more inflatable support members may increase, thereby inflating the inflatable support members. Conversely, when the fluid inlet nozzle is inserted further into the main chamber, the fluid flow into one or more inflatable support members may reduce. This may result in the deflation of one or more inflatable support members.

Beneficially, such embodiments enable the operator of the device to manually control the rigidity of the inflatable support members. Therefore, when moving and positioning the main chamber, the fluid inlet nozzle can be retracted to increase the rigidity of the inflatable support members. Whereas, when massaging the patient, the fluid inlet nozzle can be inserted further into the main chamber.

The specific shape, number, and arrangement of the inflatable support members can be selected to provide a particular shape of the main chamber. This can be beneficial for designing devices that may be configured for massaging specific body parts, for example, the back, shoulders, or legs.

In a further aspect, the present invention provides a method of performing a dry massage comprising the steps of providing the device according to any preceding aspect, placing the device on a portion of a patient to be treated, and massaging the patient via the device.

The dry massage device may further comprise features disclosed in earlier aspects and embodiments of the invention.

### BRIEF DESCRIPTION OF THE FIGURES

Preferred features of the present invention will now be described, by way of example, with reference to the accompanying drawings, in which:

FIG. 1 shows a dry massage device according to the invention.

FIG. 2 shows a second embodiment of a dry massage device including means to adjust the penetration depth of an inlet nozzle according to the present invention.

FIG. 3 (a & b) show moving the fluid inlet in relation to the surface for contacting the patient to change the area being massaged, according to the present invention.

FIG. 4 shows a dry massage device operatively connected to a fluid pump system according to the present invention.

FIG. 5 shows a dry massage device having a dual-walled main chamber configuration.

FIG. 6 (a-e) show a dry massage device having one or more inflatable support members.

### DETAILED DESCRIPTION OF THE INVENTION

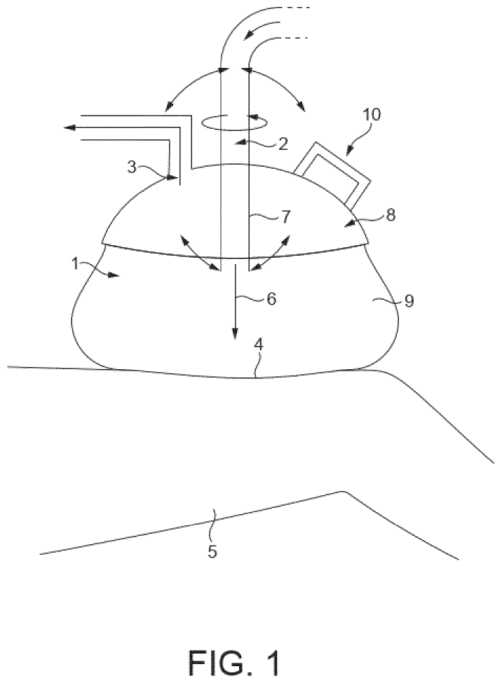

With reference to FIG. 1, the invention provides a dry massage device comprising a main chamber 1. The main chamber 1 comprises an inlet 2 through which fluid can enter the main chamber. The main chamber 1 further comprises an outlet 3 through which fluid can exit the main chamber. The main chamber 1 further comprises a surface for contacting the patient 4, which in the illustrated example is in contact with a patient 5, in particular a portion of the patient's leg. In this example the direction of the fluid entering the main chamber 6 can be varied by the user altering the angle of the fluid inlet nozzle 7 with respect to the surface for contacting the patient. Thus, the direction of the fluid entering the main chamber can be varied, whilst the surface for contacting the patient 4 remains substantially stationary in relation to the patient 5.

Typically, the fluid is a liquid, typically a liquid comprising water (e.g. an aqueous solution). In embodiments the water may comprise an anti-freeze agent which lowers the freezing point of the aqueous solution. Examples of suitable anti-freeze include methanol, ethylene glycol, propylene glycol and glycerol.

The fluid entering the chamber is typically provided under pressure from a pump system in fluid communication with the fluid inlet. The pump system typically provides the fluid at a pressure of from about 50 kPa (0.5 bar) to about 150 kPa (1.5 bar). Typically, the pressure of the bulk of the fluid in the chamber is at approximately atmospheric pressure. Accordingly, the rate of fluid (by weight) that exits the main chamber via the fluid outlet is substantially the same as the rate at which water enters the via the fluid inlet.

Typically, the dry massage system including the pump system is, in use, a closed system. Typically, the fluid exiting the main chamber via the fluid outlet is recycled via the pump system to fluid inlet and back into the chamber. This enables the dry massage system to be used in wider variety of locations. For instance, remote from a water source, on a hospital ward, or even in a patient's home.

In the illustrated example, the main chamber has a single-walled configuration composed of two portions, a relatively rigid portion 8, which comprise a metallic material and/or a relatively rigid polymer, and a relatively flexible membrane 9. The relatively flexible membrane may comprise a material selected from the group consisting of a thermoplastic, a rubber, or an elastomer. Silicone-based elastomeric membranes are particularly preferred. As illustrated, the relatively rigid portion 8 may comprise the fluid inlet 2 and the fluid outlet 3. Typically, the relatively rigid portion is intended to provide structural support to the main chamber and to facilitate variation of the direction the fluid entering the main chamber by the user. In the illustrated embodiment, the surface 4 for contacting the patient 5 is located on the outside of the relatively flexible membrane. In use, the fluid jet entering the chamber is directed towards the reverse-side of the portion of the flexible membrane comprising the surface in contact with the patient.

Typically, the relatively flexible membrane has a thickness of from about 0.25 mm to about 2 mm, more preferably from about 0.5 mm to about 1 mm.

In use, the direction of the fluid entering the main chamber 6 can be manipulated by the user. Typically, the fluid is directed towards the reverse side of the wall of the main chamber contacting the patient 4. Thus, the pressure of the fluid jet let leaving the fluid inlet is communicated to the patient 5 in a massaging effect. The direction of the fluid entering the main chamber 6 can be changed by the user in order to vary the region of the surface for contacting the patient 4 that the fluid is directed towards, whilst the surface remains in substantially stationary contact with the patient. Advantageously, this allows a larger area of the patient to be massaged without having to move the main chamber.

For the purpose of the invention, stationary means that the surface for contacting the patient 4 does not appreciably move in relation to the patient 5.

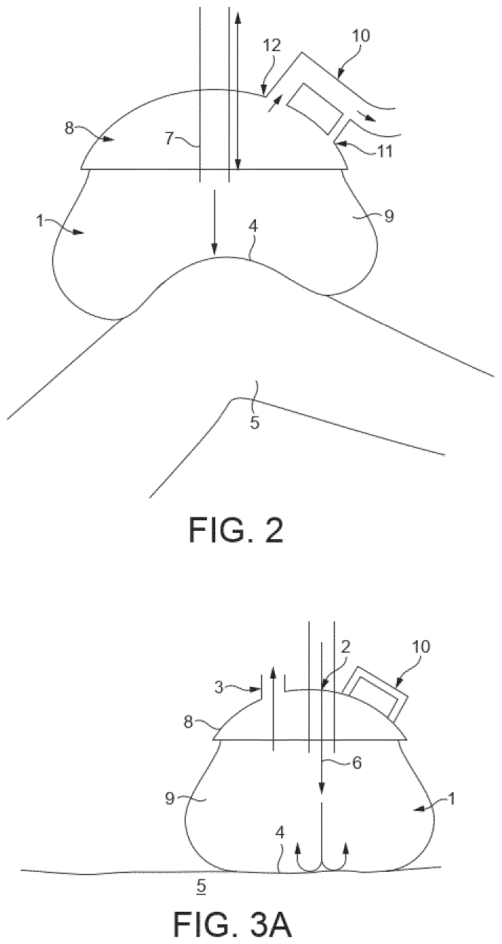

As illustrated in FIG. 2, the main chamber 1 has a single-walled configuration and comprises a relatively flexible membrane 9, which when in contact with the patient 5 flexes to conform to the shape of the portion of the patient with which it is in contact. In this example, the depth of the fluid inlet nozzle 7 within the main chamber 1 can be changed by the user, by inserting or retracting the fluid inlet nozzle 7 into/from the main chamber 1 in a longitudinal direction. This action increases or decreases, respectively, the distance between the fluid inlet nozzle and the surface for contacting the patient 4. By changing this distance, the pressure applied by the fluid on the inside surface of the main chamber 1 may be increased or decreased, and hence increases or decreases the vigour of the massage applied to the patient.

In the exemplified system, an integrated handle 10 is coupled to the main chamber 1. This enables the user to more easily manipulate the position of the main chamber in relation to the patient. The integrated handle 10 comprises the fluid outlet through which fluid may exit the main chamber 1. In some embodiments (not shown), the integrated handle may comprise a plurality of fluid outlets, for example two, positioned at the regions where the integrated handle 10 meets the relatively rigid portion 8, through which fluid may exit the main chamber 1.

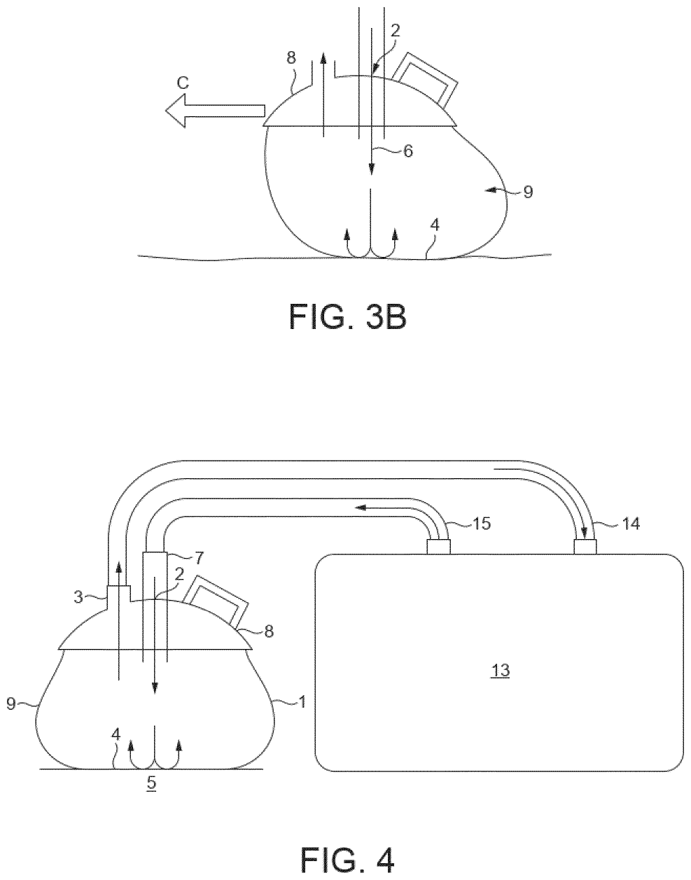

With reference to FIG. 3 (a), the main chamber 1 is positioned on the patient 5. Fluid enters the main chamber 1 through the fluid inlet 2 under pressure from a pump system (not shown). The fluid entering the main chamber 6 is directed towards the internal surface of the portion of the flexible membrane 9, in this instance the surface for contacting the patient 4. The fluid pressure is communicated to the patient via the flexible membrane 7 delivering a massaging effect. The fluid exits the main chamber through the fluid outlet 3 positioned in the rigid portion 8 for recycling via the pump system (not shown). The relatively-rigid portion 8 further comprises an integrated handle 10.

FIG. 3 (b) shows that the position of the fluid inlet 2 has been moved in direction (C). As the rigid portion moves in direction (C), the flexible membrane 9 rolls across the patient; however, the surface that is in contact with the patient 4 remains in constant contact with the patient 5 and substantially stationary relative to the patient 5. As a result of the repositioning of the fluid inlet 2 relative to the patient, the fluid entering the main chamber 6 is directed towards a different portion of the internal surface of the flexible membrane 9 and thus a different area of the patient 4. Advantageously, this allows the user to change the area of the patient 5 that is being massaged without having to slide the main chamber across the patient's skin.

FIG. 4 illustrates the main chamber 1 connected to a fluid pump system 13. The fluid enters the main chamber 1 through the fluid inlet 2 in the rigid portion 8 of the main chamber 1. The illustrated system is a closed system when in use, although it may be drained and refilled for transportation and storage purposes. The main chamber, inlet and outlet are those illustrated in FIG. 3(a) and are numbered accordingly.

After exiting the main chamber 1 through the fluid outlet 3, the fluid is drawn along a first pipe 14 that is connected at one end to the fluid outlet 3 and at a second end to a fluid pump system 13. The fluid is then pumped under pressure by the fluid pump system 13 through a second pipe 15 which is at one end connected to the fluid pump system 13 and at a second end to the fluid inlet nozzle 7. Thus, the fluid is recirculated.

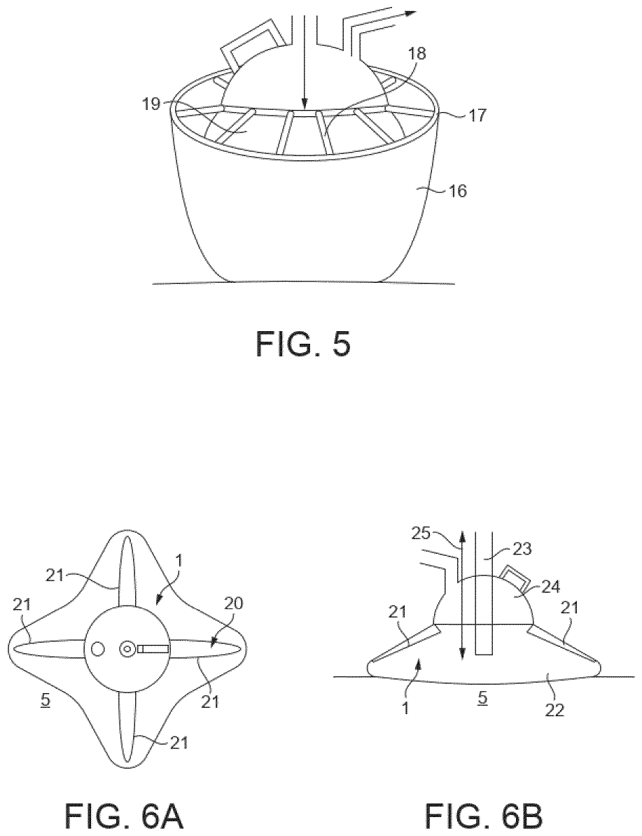

FIG. 5 illustrates a main chamber 1 with a dual-walled configuration. The main chamber 1 comprises an inner wall 19 that is relatively elastic, substantially surrounded by an outer wall 16 that is relatively inelastic. Both the inner wall (19) and outer wall (16) are flexible. The outer wall 16 comprises attachment means 17, the attachment means 17 having struts 18 connecting to the relatively rigid portion 8 of the device. The attachment means 17 also act as a handle for manipulating the device.

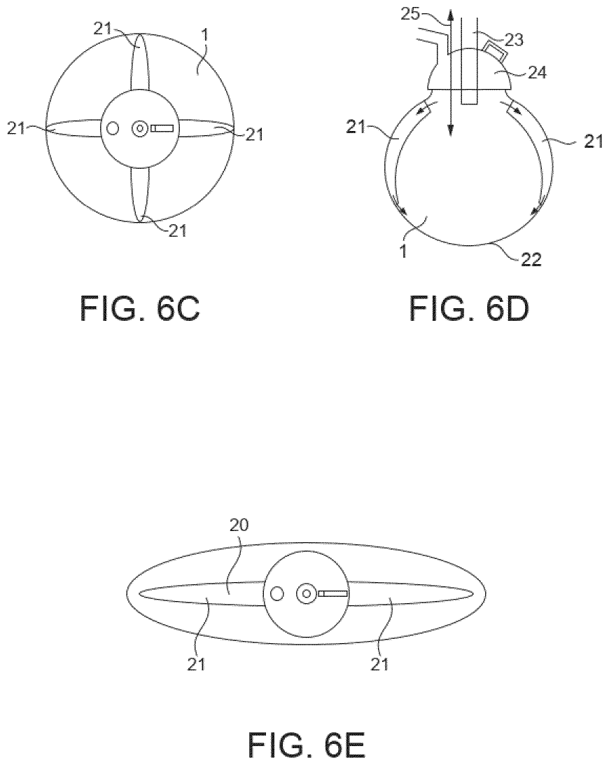

FIG. 6 (a-e) illustrate various views and embodiments wherein the main chamber 1 comprises inflatable support members 20. In these embodiments the inflatable support members 20 are generally tubular members 21.

FIG. 6a illustrates a top-down view of a main chamber 1, wherein the inflatable support members 20 comprise four generally tubular members 21. The generally tubular members 21 have a first end adjacent to the pump inlet, and a second end adjacent to the surface for contacting the patient 5. In this embodiment, the fluid entering the main chamber 1 is not directly entering the generally tubular members 21. Accordingly, the inflatable support members are not providing increased structural rigidity to the main chamber 1.

FIG. 6b shows a side-view of the device of FIG. 6a. It can be seen that the fluid entering the main chamber 1 is not directed into the generally tubular members 21. Accordingly, there is no localised pressure increase in the generally tubular members 21, maximising the surface area of the surface for contacting the patient 5. In this configuration, the user has maximum freedom to manipulate the fluid inlet nozzle 23 to direct the fluid onto the entire area of the surface for contacting the patient 5.

The fluid inlet nozzle 23 is inserted through a relatively rigid portion 24 of the main chamber 1. The fluid inlet nozzle 23 and/or the entire relatively rigid portion 24 are movable substantially towards and away from the surface for contacting the patient. This is indicated by direction arrow 25. By moving the fluid inlet nozzle 23 and/or the relatively rigid portion 24, the strength of the massage may be varied by the user.

FIGS. 6c and 6d show the device of FIGS. 6a and 6b, from top-down and side views, wherein fluid is directed into the generally tubular members 21. It can be seen that the fluid entering the generally tubular members 21 creates a localised pressure increase in the inflatable support members 20. This reduces the area of the surface for contacting the patient 22, but makes the device more manually maneuverable for the user.

The fluid inlet nozzle 23 is inserted through a relatively rigid portion 24 of the main chamber 1. The fluid inlet nozzle 23 and/or the entire relatively rigid portion 24 are movable substantially towards and away from the surface for contacting the patient. By moving the fluid inlet nozzle 23 and/or the relatively rigid portion 24, the strength of the massage may be varied by the user.

FIG. 6e shows a device comprising inflatable support members 20 with a different configuration of generally tubular members 21. Accordingly, this changes the shape of the main chamber such that it is longer and narrower than those of, for example FIGS. 6a-d. This enables the shape of the device to be tailored to providing massage for a specific region of the body.

It will be appreciated that various modifications may be made to the embodiments shown without departing from the spirit and scope of the invention as defined by the accompanying claims as interpreted under patent law.

1.-31. (canceled)

32. A dry massage device comprising:
a main chamber, wherein the main chamber comprises a fluid inlet configured to enable fluid to enter the main chamber, and a fluid outlet configured to enable fluid to exit the main chamber;
the main chamber having a surface for contacting a patient,
wherein the device is configured such that a direction of the fluid entering the main chamber, relative to the surface for contacting the patient, is changeable by the user whilst said surface for contacting the patient remains substantially stationary relative to the patient.

33. The device according to claim 32 wherein, in use, the fluid inlet is moveable relative to the surface for contacting the patient, whilst said surface for contacting the patient is in substantially stationary contact with the patient.

34. The device according to claim 32 wherein, in use, the fluid inlet is moveable in a plane that is substantially parallel to the surface for contacting the patient, whilst said surface for contacting the patient is in stationary contact with the patient.

35. The device according to claim 34 wherein the fluid inlet is moveable in a direction tangential to the plane parallel to the surface for contacting the patient.

36. The device according to claim 32 wherein the fluid inlet comprises an inlet nozzle, wherein said inlet nozzle is movable within the main chamber.

37. The device according to claim 36 wherein the fluid inlet is configured such that the distance from the fluid inlet nozzle to the surface for contacting the patient is variable, and wherein the inlet nozzle is coupled to the main chamber by a set of rollers and/or a flexible seal.

38. The device according to claim 32 wherein the main chamber comprises a wall comprising a flexible membrane.

39. The device according to claim 38 wherein, in use, said flexible membrane provides the surface for contacting the patient, and wherein the flexible membrane is conformable to substantially a shape of a portion of the patient with which the flexible membrane is engaged.

40. The device according to claim 32 further comprising a pump system for supplying fluid to the fluid inlet.

41. The device according to claim 40 wherein fluid exiting the main chamber by the fluid outlet is recirculated via the pump system back into the main chamber via the fluid inlet.

42. The device according to claim 32 wherein the main chamber comprises a relatively rigid portion and a relatively flexible portion, wherein the relatively rigid portion comprises the fluid inlet and/or the fluid outlet.

43. The device according to claim 32 further comprising one or more inflatable support members, and wherein the one or more inflatable support members are directly connected to an outer wall of the main chamber, or an inner or outer surface of the main chamber.

44. The device according to claim 43, wherein each inflatable support member is in fluid communication with the main chamber.

45. The device according to claim 44, wherein the one or more inflatable support members comprise a first opening at a first end, and a second opening at a second, distal end, wherein the first opening and second opening are in fluid communication with the main chamber.

46. The device according to claim 43, wherein the one or more inflatable support member comprises a generally tubular member.

47. A method of performing a dry massage comprising the steps of providing the device according to claim 32, placing the device on a portion of the patient to be treated, and massaging the patient.

48. A method of performing a dry massage on a patient, comprising the steps of:
a. positioning a dry massage device comprising a main fluid chamber onto an area of the patient to be massaged,
b. at least partially filling the main chamber with fluid through an inlet,
c. varying a direction of the fluid entering the main chamber in order to massage the patient whilst the surface of the main chamber in contact with the patient remains substantially stationary.

49. The method according to claim 48 further comprising the step of moving the fluid inlet relative to the surface in contact with the patient, whilst said surface remains in substantially stationary contact with the patient.

50. A dry massage device comprising:
a main chamber, which comprises an inlet configured to direct fluid entering the main chamber in a direction towards a surface of the main chamber in contact with a patient, and a fluid outlet configured to enable fluid to exit the main chamber,
wherein the fluid exiting the main chamber via the fluid outlet is recirculated via a fluid pump system back into the main chamber through the inlet.

51. A method for performing a dry massage comprising the step of using the device according to claim 50 to perform a massage.
